(19) United States
(12) Patent Application Publication
(10) Pub. No.: US 2003/0037145 A1
(43) Pub. Date: Feb. 20, 2003

(54) Apparatus and method of allocating communications resources

(76) Inventor: Michael Fagan, Lower Hacheston (GB)

Correspondence Address: Nixon & Vanderhye, 8th Floor, 1100 North Glebe Road, Arlington, VA, 22201-4714, US

(21) Appl. No.: 10/204,272

(22) PCT Filed: Jan. 30, 2001
(86) PCT No.: PCT/GB01/00378

(30) Foreign Application Priority Data
Mar. 15, 2000 (EP) 00302107.8

(51) Int. Cl. G06F 15/173

(52) U.S. Cl. 709/226; 709/220

(57) ABSTRACT

A method of allocating one or more resources to one or more input entities, each of which one or more input entities has one or more input attributes associated therewith, the method comprising the steps of:

(i) storing data comprising processed entities and attributes of the processed entities, each of which processed entities has had one or more resources allocated thereto;

(ii) deriving groupings of rules from the stored data, which groupings of rules each identify a set of one or more of the stored attributes that are related to the allocation of resources for the processed entities;

(iii) for each grouping of rules, assigning at least one resource value to the grouping;

(iv) for each input entity, calculating a resemblance value for each previously derived grouping of rules, so as to determine which of the said derived groupings of rules the input entity most closely resembles;

(v) allocating a resource allocation in accordance with the grouping determined at step (iv);

(vi) monitoring the resemblance value determined at step (iv) for an input entity; and

(vii) generating an alert each time a calculated resemblance value falls below a predetermined threshold value.

This invention relates to a method and apparatus for allocating communications resources, and is suitable particularly, but not exclusively, for allocating copper pairs to new houses.

Copper pairs, or local loops, carry data relating to a range of communications services between the telephone exchange and the home. With the increasing availability of more and more diverse content data and communication services, the number of pairs linking new homes to exchanges has become increasingly difficult to predict. Traditionally, the housing developers, or planners, have estimated demand for communication lines, based on local knowledge. Recent studies have shown that reliance on such local knowledge can lead to the provision of too many, or too few, copper pairs, and thus that these traditional methods are no longer appropriate for estimating local loop allocation.

According to a first aspect of the present invention, there is provided a method of allocating one or more resources to one or more input entities, each of which one or more input entities has one or more input attributes associated therewith, the method comprising the steps of:

(i) storing data comprising processed entities and attributes of the processed entities, each of which processed entities has had one or more resources allocated thereto;

(ii) deriving groupings of rules from the stored data, which groupings of rules each identify a set of one or more of the stored attributes that are related to the allocation of resources for the processed entities;

(iii) for each grouping of rules, assigning at least one resource value to the grouping;

(iv) for each input entity, calculating a resemblance value for each previously derived grouping of rules, so as to determine which of the said derived groupings of rules the input entity most closely resembles;

(v) allocating a resource allocation in accordance with the grouping determined at step (iv);

(vi) monitoring the resemblance value determined at step (iv) for an input entity; and

(vii) generating an alert each time a calculated resemblance value falls below a predetermined threshold value.

Conveniently the step of assigning a resource value to the grouping comprises, for each grouping, calculating an average of the resource allocations corresponding to processed entities in the grouping.

Preferably the number of alerts generated are monitored and, in response to a predetermined number of alerts generated, the groupings identified are modified. Conveniently, such modification includes deriving new rules and groupings of rules in accordance with the attributes of the input entity identified.

According to a further aspect of the invention there is provided apparatus for allocating one or more resources to one or more input entities, the apparatus comprising:

(i) storage means for storing data comprising one or more processed entities and attributes of the processed entities, each of which processed entities has had one or more resource allocated thereto;

(ii) deriving means for deriving groupings of rules from the data stored in the storage means (i), which groupings of rules identify attributes that are related to the allocation of resources for the processed entities;

(iii) assigning means for assigning at least one resource allocation to each grouping;

(iv) monitoring means, being operable to receive as input the input entities and the rules derived by the deriving means (ii), and which, for each of the input entities

a) calculates a resemblance value so as to determine which of the previously derived groupings of rules the input entity most closely resembles;

b) assigns the entity to a grouping determined at step (a);

c) generates an alert if the resemblance value determined at step (a) falls below a predetermined threshold value; processing means being further arranged, in the event that no group can be so identified, to generate an alert.

Conveniently the deriving means includes means for performing cluster analysis on the stored data, and the groups so derived are clusters of data.

Preferably the resource to be allocated is a communications resource.

Further aspects, features and advantages of the apparatus for allocating resources will now be described, by way of example only as an embodiment of the present invention, and with reference to the accompanying drawings, in which:

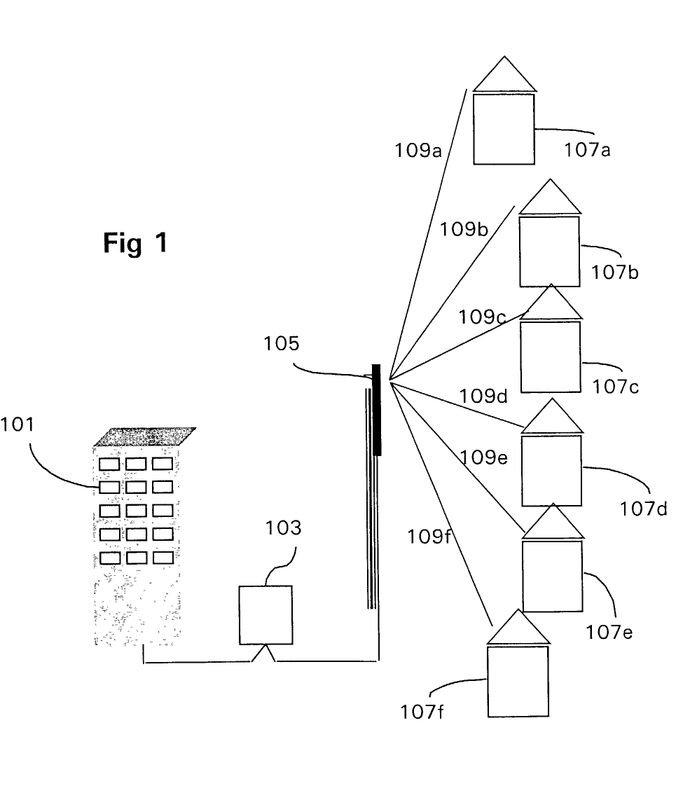

FIG. 1 is a schematic diagram showing a typical infrastructure arrangement for a copper loop telecommunications network;

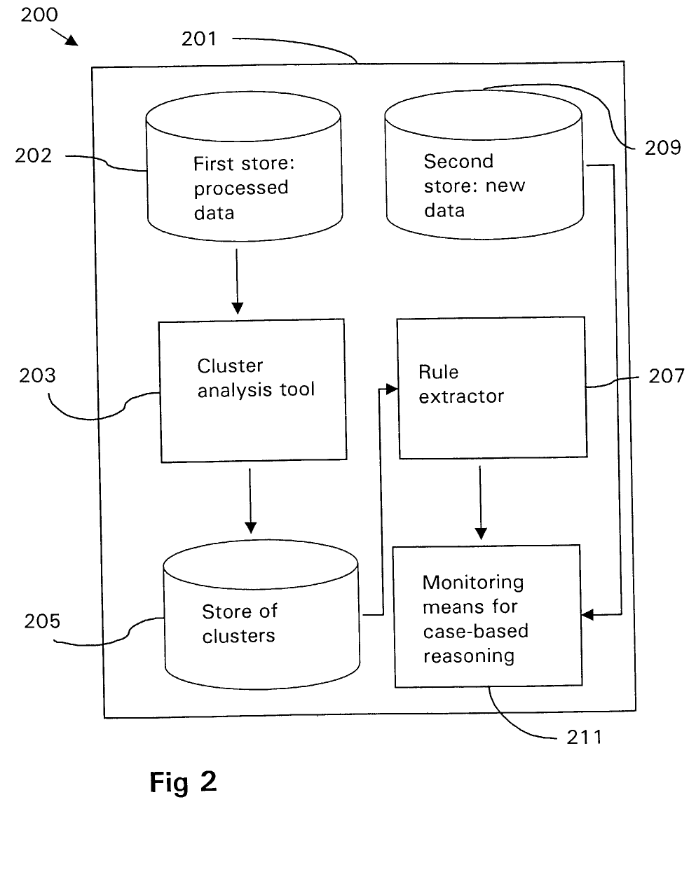

FIG. 2 is a schematic block diagram showing apparatus for allocating resources according to an embodiment of the present invention;

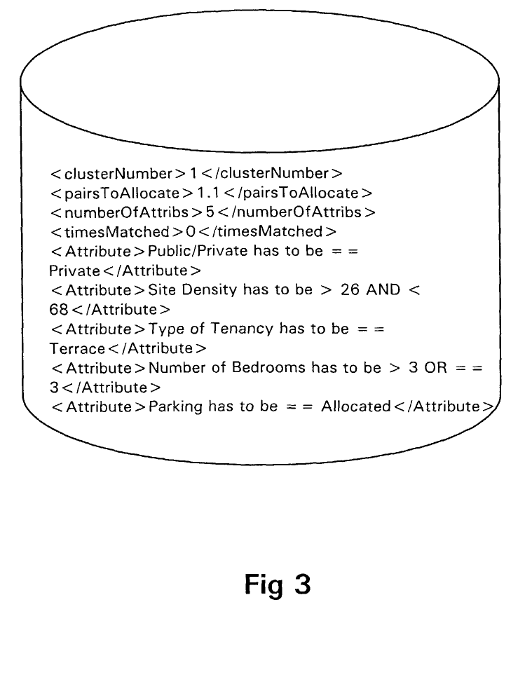

FIG. 3 is a schematic diagram showing an example of rules extracted from clusters stored in the cluster repository providing part of the apparatus of FIG. 2;

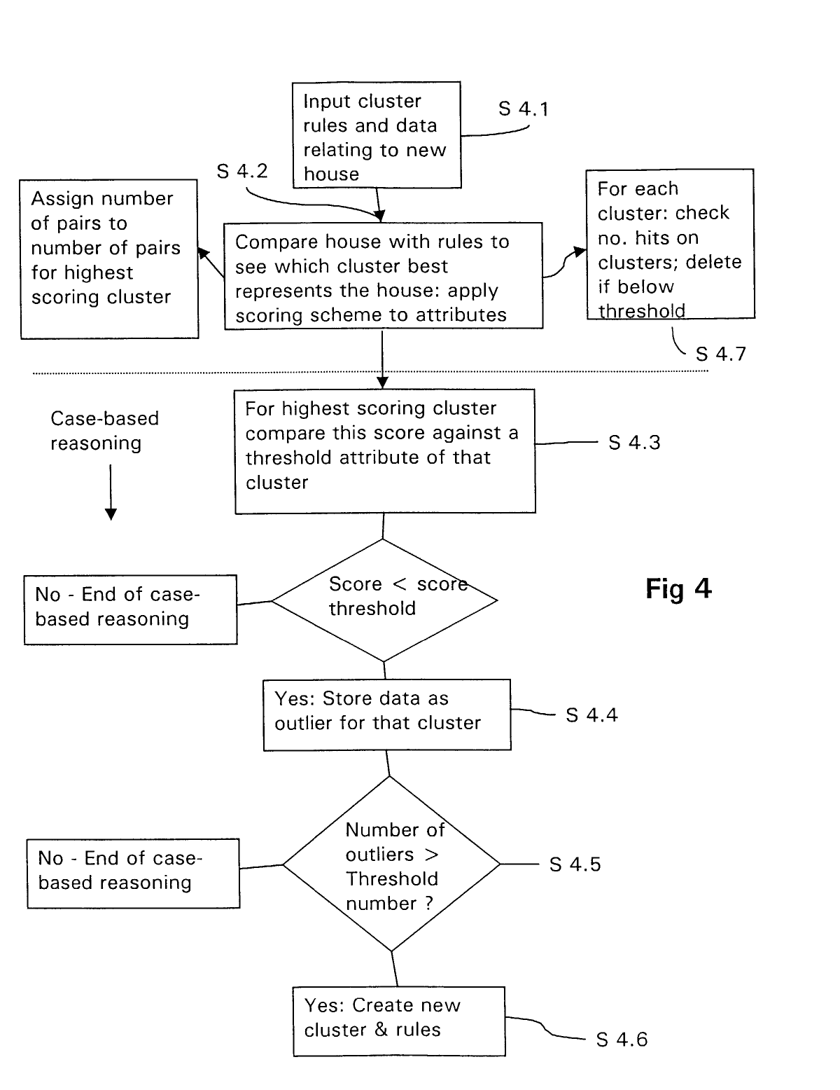

FIG. 4 is a block diagram showing case-based reasoning performed by modifying means comprising part of the apparatus of FIG. 2;

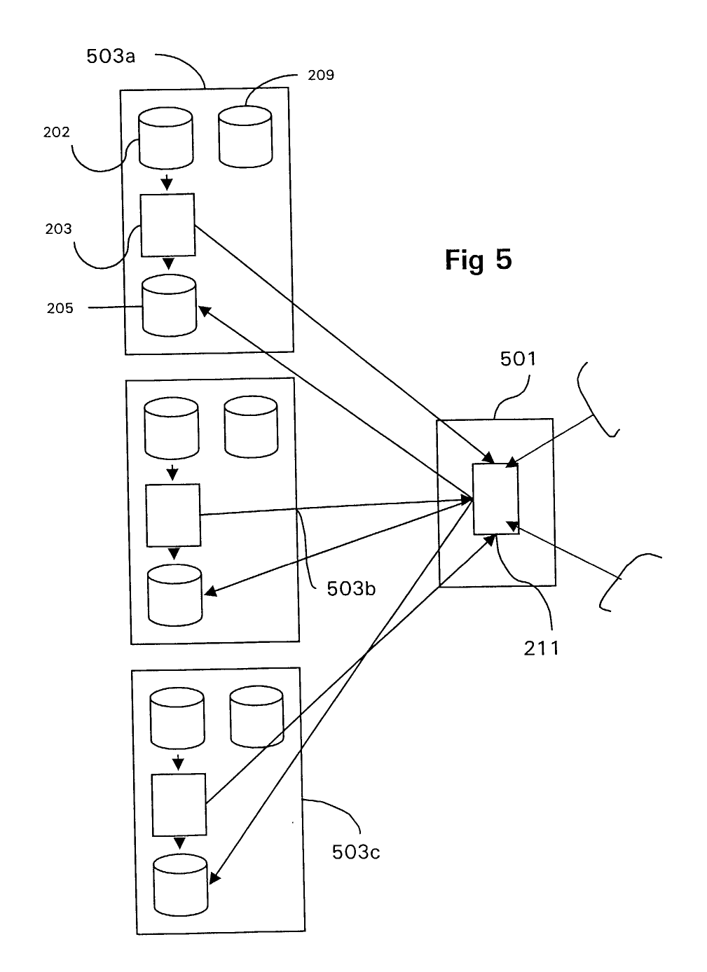

FIG. 5 is a schematic block diagram showing a distributed arrangement of the apparatus of FIG. 2, and

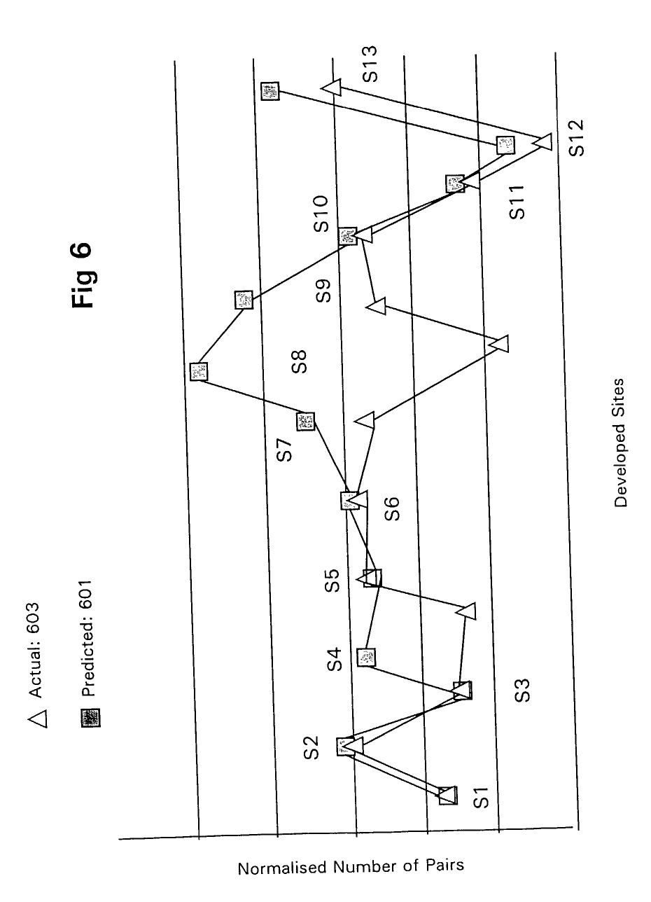

FIG. 6 is a graph showing predicted and estimated take-up of pairs of copper wires.

In the following description, the terms “attribute”, “cluster” and “outlier” are used. These are defined as follows:

“attribute”: a characterising feature of an entity;

“cluster”: a grouping of data which share well defined attributes;

“outlier”: a data point which cannot be classified within a cluster.

In the embodiment presented below, an entity is a house, and the resource to be allocated is copper pairs. However, in the context of the invention, an entity is anything that can be allocated a resource, when allocation of the resource is representable in a rule-based form.

General Overview of First Embodiment of Resource Allocation

FIG. 1 shows a typical local loop configuration, having an exchange 101, which routes communication signals to a selected destination (houses) 107a, 107b, 107c, 107d, 107e, 107f. FIG. 1 also shows cross connection point 103 located between the exchange 101 and a distribution point 105, which distribution point 105 comprises a box terminal having a drop wire which connects to a plurality of links, each leading to a house 107a, 107b, 107c, 107d, 107e, 107f. The cross-connection point 103 is a double-sided set of pins, commonly referred to as a “flexibility point”: an n pair cable comes in from the exchange 101 and is connected in a logical sequence to one side of the pin board. Customer lines 109a, 109b, 109c, 109d, 109e, 109f are connected to an appropriate pair of pins thus providing the exchange 101 to customer connection. The links 109a, 109b, 109c, 109d, 109e, 109f between the distribution point 105 and the houses are shown as single lines in FIG. 1, and these links represent one or more pairs of copper wires.

Referring to FIG. 2, in use the apparatus 200 of the invention is loaded on a computer 201 (implementation details given later). The apparatus 200 comprises a first repository of data 202, which data includes attributes of houses from previously constructed sites such as: name of site; type of site (public/private); density of houses on site; type of house; number of bedrooms in house; parking allocation; exchange; distance from exchange; post code; actual number of pairs per house, etc. The apparatus 200 also comprises deriving means 203, which derives, from the data in the first repository 202, attributes that are significant to the selection of number of copper pairs, and groups these identified attributes into clusters, each of which clusters classifies types of attributes. The deriving means 203 also estimates a characteristic number of pairs for each cluster (described below). The apparatus 200 further comprises a cluster repository 205, which may be a local cache, and which stores the clusters of attributes derived by the deriving means 203, together with the estimated number of pairs. As also shown in FIG. 2, the apparatus includes a rule extractor 207 for extracting rules (described below) associated with these clusters of attributes.

The embodiment is used to allocate copper pairs to new houses—typically houses to be built on housing developments (or sites), and this allocation occurs by predicting numbers of copper pairs based on information collected from existing sites. Apparatus components 202, 203, 205 and 207 thus contain and represent data relating to houses on existing sites, and first repository 202 comprises attribute data from existing houses for which the actual number of copper pairs is known. The clusters formed by the deriving means 203, and the rules extracted therefrom by the extracting means 207, thus reflect the groupings of attributes from existing sites.

The site attributes listed above are available at various stages of the site planning process. Referring again to FIG. 2, once the attributes relating to features of the houses have been decided, this information is used to populate a second repository 209 with similar attributes in respect of houses planned. That is, the configuration of existing houses is analysed in order to extract attributes, and these are stored in the first repository 202 (as described above). The same type of attributes are then used to populate a second repository 209 in respect of planned houses. The difference between the first repository 202 and the second repository 209 is that the attribute “actual number of pairs” is blank in the second repository 209; indeed, this is the parameter that the embodiment is predicting. The rules that have been extracted by the extracting means 207 are accessible to monitoring means 211, which receives as input the attribute data from the second repository 209. For each new house, the monitoring means 211 compares the corresponding attributes with each of the rules, to establish which rule, according to a predetermined threshold criteria (described below) and applying case-based reasoning techniques, most closely matches the attributes. Once a “best match” rule has been established, the house is assigned to a cluster, and thus a number of pairs.

It may be the case that the attribute data falls outside of the thresholds of all of the clusters, in which case the modifying means 211 may apply an adaption process and form one or more new clusters. This process, which allows the apparatus to account for changing site characteristics and variable effects of attributes, is described in greater detail below.

Deriving Means 203

Deriving means 203 comprises a cluster analysis tool, which is used to derive significant attributes and groupings of those attributes from the data in the first repository 202. There are many types of cluster analysis tools, but the technique essentially applies a radially expanding structure around each of the input data, and the intersection of adjacent expanding structures defines a new cluster. The centre of new clusters is dependent on the spatial distribution of inputs within the new cluster. Clearly the distribution of input data is significant, as the relative position of the inputs determines the cluster development; in fact the clusters reveal the significance, or otherwise, of attributes to selection of copper pairs (parameter of interest in the present embodiment) and the groupings of these attributes. For an example of types of cluster analysis, see “Cluster Analysis”, Brian Everitt, 3^{rd} Edition, or “A handbook of statistical analysis using S-Plus”, Brian Everitt. In the present embodiment, the K-means clustering technique as presented by Shank, R. C. and Abelson, R “Goals and Understanding: An inquiry into human knowledge structures” was used.

Significant attributes are defined as those which vary between the identified clusters; thus if an attribute is relatively unchanged between clusters, then it may be considered to be insignificant to the parameter of interest. In the present embodiment, the input vector included around 18 attributes, but the clustering process based on the data available identified 5 of these attributes as having a significant effect on the selection of copper pairs, and identified 5 clusters from the data-set.

Once the clusters have been identified, they are stored in cluster repository 205, which may be local disk cache, for access from the extracting means 207. As the reduction of the data set is dependent on the data available, both the number of clusters and the significant attributes may change over time; this aspect is addressed by the monitoring means 211 and is discussed below.

Using the data in the first repository 202, the number of copper pairs is estimated from the attribute “actual number of lines” once the clusters have been formed. Each of the inputs comprising a cluster (i.e. each of the houses in a cluster) has a corresponding “actual number of lines” stored in repository 202. A characteristic number of lines for each cluster is estimated from an average of each of the actual numbers for each input.

Extracting Means 207

Extracting means 207 comprises a rule extractor, which interfaces with the cluster analysis tool 203 via the cluster store 205 to identify initial groupings that, as described in greater detail below, may change with time. Any data relating to new houses is decomposed into the attributes described above, and stored in the second repository 209 for input to the monitoring means 211. Upon receipt of this data, the monitoring means 211 reviews how well the existing clusters correlate with data from new sites. In order to perform this correlation process, the monitoring means 211 requires access to some description of the existing clusters, and this is conveniently provided by the rule extractor 207, which analyses the clusters so as to extract corresponding rules. The rule extractor 207 may be provided by a commercially available tool such as is provided by the SAS Institute Incorporated ™ “Enterprise Miner” ™, which receives as input cluster information, and provides as output a set of rules defining the cluster. An example of one such set of rules is presented in FIG. 3 of the accompanying drawings, and once derived, the rules are preferably stored for access by the monitoring means 211.

The function of both the cluster analysis and rule extraction tools 203, 207 is primarily one of system initialisation. Once clusters have been established in the manner described above, the monitoring means 211 enables adaptation of the cluster-space; thus the cluster analysis tool 203 can be considered as a means for populating case-based reasoning data.

Monitoring Means 211

The monitoring means 211 uses the rules extracted from the clusters in order to predict an estimated number of copper pairs for a new site, as described with reference to FIG. 4:

S 4.1 Input cluster rules and data from second repository 209 (attributes relating to new houses);

S4.2 Compare each new house with rules to see which rule best represents the house. Such a comparison may generally be quantified by a resemblance value, which provides a measure of how closely the attributes of the new house match each of the rules. A resemblance value may be a score that results from assessing the attributes of the new house according to a predetermined scoring procedure. Alternatively it may be a correlation coefficient, which describes an overall measure of the degree of correlation between each of the attributes of the new house and those of the rules. An example of a scoring scheme is given below; and it is understood that the actual details of the scheme are inessential to the invention:

Divide the attributes into two categories, string and numeric data:

For string attributes, such as Public/Private, Type of house, and parking, an equality test is performed between the values stored in the attribute for the rule and the values relating to attributes of new data. If the two are equal the score is 1, or if the two are different the score is −1, indicating a match and a mismatch respectively.

For numeric attributes, if the attribute of the new house falls within a predetermined range (around the value in the rule attribute), the score is 1. For example if the rule attribute has specified the Number of Bedrooms to be 2, then new houses with number of bedrooms attribute falling within 1 and 3 will score 1, or if the number of bedrooms fall outside of this range, the score is −1. The range can be determined from the mean and sample standard deviation of the attributes. Site Density stores continuous data, and the scoring procedure for this attribute relates the score to how far away the value of the rule attribute is from the attribute value of the new house. This may be calculated from the following function:

$$* Site Density Score = 1 - 2 \frac{\begin{matrix}\vert New {Tenancy}_{i} [ Site Density ] - \\ Stored Rule value [ Site Density ] \vert\end{matrix}}{deviation}$$

This information is summarised in Table 1 below (the information relating to the new data is compared with attribute data from each of the rules, RULEₗ, where i refers to attribute of interest):

TABLE 1

| | | | |
|---|---|---|---|
| Attribute | Public/Private | Weight | 1 |
| | Tests | | Score |
| | RULE_{i[Public/Private] = NEW DATA[Public/Private]} | | 1 |
| Attribute | Site Density | Weight | 1 |
| | Tests | | Score |
| | \|RULE_{i[Site Density] - NEW DATA[Site Density]\| < precision} | | 1 |
| | \|RULE_{i[Site Density] - NEW DATA[Site Density]\| < deviation} | | * |
| Attribute | Type of House | Weight | 2 |
| | Tests | | Score |
| | RULE_{i[Type of House] = NEW DATA[Type of House]} | | 1 |
| Attribute | Number of Bedrooms | Weight | 1 |
| | Tests | | Score |
| | RULE_{i[Number of Bedrooms] ≧ NEW DATA[Number of Bedrooms]} | | 1 |
| | RULE_{i[Number of Bedrooms] = NEW DATA[Number of Bedrooms]-1} | | 0 |
| Attribute | Parking | Weight | 1 |
| | Tests | | Score |
| | RULE_{i[Parking] = NEW DATA[Parking]} | | 1 |
| | RULE_{i[Parking] = “1 Garage” AND} | | 0 |
| | NEW DATA[Parking] = “2 Garages” | | |
| | RULE_{i[Parking] = “2 Garages” AND NEW DATA[Parking] = “1 Garage”} | | 0 |

The overall score for a house is an average of scores of the attributes of that house (this will be an array of house scores, each relating to each of the cluster rules):

$$Tenancy Score = \frac{\sum ( Weight of Attribute \times Attribute Score )}{\sum Weight of Attributes}$$

Thus the house is assigned a score against each of the set of rules according to the above scheme. As each rule is derived from a cluster, which has a corresponding allocation of number of copper pairs, the house is assigned the pair allocation corresponding to the highest scoring cluster rules.

S 4.3 For the cluster that scores highest out of all of the cluster rules, and for the house of interest, compare this score against a threshold attribute, which is stored with the cluster in cluster repository 205. Small deviations from the cluster rules may result in poor scores against each of the clusters identified by the cluster analysis tool, and the monitoring means 211 therefore includes means for performing case-based reasoning on data from the second repository 209 (see Leake, D. (1997) Case-based reasoning: Experiences, lessons and future directions. AAAI Press).

S 4.4 If the cluster that scores the highest receives a score below its cluster threshold, then classify that score as an outlier, and store it as an outlier for that corresponding cluster.

S 4.5 Monitor the rate of occurrence of these outliers, and if the number of outliers for any cluster exceeds a predetermined value, create a new cluster, which has rules that correspond to the site/house which the previous cluster has always performed badly against. This cluster threshold is set to a low default value in order to avoid the initial creation of new outliers, and the threshold is reviewed once the number of best match scores has exceeded a predetermined threshold (60 in the present embodiment). This threshold is set at the 95% lower bound on the distribution of best scores, and is obtained via equations 1 and 2:

$$α = \overline{x} - 1.96 ( \frac{s}{\sqrt{n}} ) \qquad ( 1 )$$

where n=number of scores logged and

$$s = \sqrt{\frac{{\sum }_{i = 1}^{n} {( {x}_{i} - \overline{x} )}^{2}}{n - 1}} \qquad ( 2 )$$

S 4.6 If a new cluster has been created, the number of pairs that is assigned to that cluster is estimated from a moving average of the number of pairs corresponding to the cluster with which outliers were initially identified:

$$\frac{a + {x}_{1}}{{2}^{n}} + \frac{{x}_{2}}{{2}^{( n - 1 )}} + \frac{{x}_{3}}{{2}^{( n - 2 )}} + \frac{{x}_{4}}{{2}^{( n - 3 )}} + … + \frac{{x}_{n}}{{2}^{1}} \qquad ( 3 )$$

where xₗ=number of pairs characterising old cluster i and n=number of outliers in new cluster.

S 4.7 Periodically review the number of hits for each cluster, and delete clusters if they become ‘stagnant’, i.e. if no best-match has been identified for a specified time. This time can be set as an absolute date or a certain time interval in the future (e.g., six months).

This monitoring and evaluating feature of the invention essentially introduces adaptation into the system, thereby enabling the apparatus to modify itself based on real-time performance metrics.

Implementation for Embodiment

As shown in FIG. 1, the apparatus 200 may be located on a single computer 201. As an alternative, and as shown in FIG. 5, the monitoring means 211 may be located on a server computer 501, and the cluster analysis tool 203, and the repositories 202, 205, 209 may be located on a client computer 503 (shown for one client only 503a). In this configuration the apparatus 200 is thus distributed over a plurality of computers. In situations where the apparatus is used by many planners that are physically separated from one another, each of the planners may run the cluster analysis tool 203 on their client machines 503a, 503b, 503c, and the rules identified by the cluster tool 203 may be sent to the modifying means 211, for identification of outliers. As an alternative (not shown), the cluster tool 203, rather than the modifying means 211, may include means to identify outliers, and to send the outliers to the server computer 501 for subsequent processing by the modifying means 211. The advantage of either of these distributed arrangements is that numerous planners may submit their outlier data to a central resource, which is operable to update cluster rules based on data from a range of planning sources. New cluster rules, resulting from analysis by the modifying means 211 and based on a range of inputs, are then pushed out to each of the clients in a single action. In preferred arrangements (not shown), the apparatus 200 interfaces with a commercially available tool named GenOsys™. GenOsys™ is a Genetic Algorithm-based planning tool for copper access networks, which allows new greenfield copper distribution networks to organically ‘evolve’ into cost-optimised designs, with resulting huge savings in capital expenditure and planning manpower costs. The tool comprises a graphical front end that displays house distribution and allows a user to define attributes per house. The present invention may be run from within this graphical environment via various toolbar functions. Furthermore, in this arrangement the cluster analysis tool 203 and the monitoring means 211 are provided with data directly from the GenOsys™ database (thus the first and second repositories 202, 209 are an integral part of GenOsys™).

As will be understood by those skilled in the art, the invention described above may be embodied in one or more computer programs. These programs can be contained on various transmission and/or storage mediums such as a floppy disc, CD-ROM, or magnetic tape so that the programs can be loaded onto one or more general purpose computers or could be downloaded over a computer network using a suitable transmission medium. This first embodiment of the present invention is conveniently written in the Java™ programming language, but it is understood that this is inessential to the invention. The cluster repository 205 is preferably accessed—for inserting, retrieving and deleting clusters in the manner described above—using the SQL programming language. For more information on SQL see “SQL—The Standard Handbook” Stephen Cannan and Gerard Otten, McGraw-Hill. The respective SQL functions are called from within the Java code by means of Java™ Database Connectivity (JBDC API), developed by Sun Microsystems© (for more information see Java™ 2 Platform, Standard Edition (J2SE)). When the invention is distributed over a plurality of computers, the monitoring means 211 may implement one or more threads in order to check for incoming data while processing previously received data. The invention may also implement one or more threads for accessing the repositories in the manner described above during processing.

Modifications

The present embodiment is thus concerned with allocating a number of communication links to each house, based on previously recorded pair allocation, and case-based reasoning techniques. The cluster analysis tool used to analyse the data stored in the first repository 202 could be replaced by one or more other data mining processes such as rule induction, principal component analysis, logistic regression, cluster analysis and supervised learning systems such as neural networks. Further details of these and other data mining techniques may be found in “Discovering Data Mining, from concept to implementation”, International Technical Support Organisation: Cabena, Hadiinian, Stadler, Verhees, Zanasi, IBM 1997.

The above text describes the second repository 209 as including attribute data relating to new houses; clearly these could be either new houses being built on fresh sites or new houses being added to existing sites.

The present invention may alternatively and/or additionally be used to highlight competitor activity: if the second repository 209 comprises attribute data from an existing site, rather than a new site, when this data is input to the monitoring means 211, and it 211 compares each of the house attributes to the extracted rules, each house will be assigned to a cluster and thus allocated an estimated number of lines as described above. This estimated number of lines could then be compared with the actual number of lines, available from the second repository 209. An example of such a case is shown in FIG. 6, which shows number of pairs against site (so accounting for all houses in each site). The number of predicted pairs 601 compares well with the actual number of pairs 603 at most points, except for at site 8, where the actual number of pairs is significantly smaller than that predicted. The high prediction value indicates that this site contains houses that would be expected to have a higher than average take-up of a second line; thus the discrepancy could indicate that another company is providing their additional lines.

Other Embodiments

As described above, the modeling tool that is used to identify groupings for initial data can be selected from associations, sequences, inductive rules, statistical methods, and the like, and the choice of tool depends on the domain to be modeled, as also described above. Thus the present invention may be applied to a range of domains, such as deployment of Asymmetric Digital Subscriber Lines (ADSL), prioritising network upgrades, migrating of technology, marketing of telecommunication products to customers and general e-commerce customer profiling. For each of these domains, the selection of tools for performing the initialisation, thus comprising the deriving means 203, is strictly domain dependent, and the following outlines some of the considerations involved in its selection:

Prioritising Network Upgrades:

At present a logistics system, known as Investment Decision And Control System (IDACS), is used for planning network upgrades (among other applications). The system prioritises upgrades based on Distribution Point (DP) profile information stored in a central database. The database profile includes a plurality of attributes, each of which is collectively, via the profile, considered to contribute to assigning a priority hierarchy to different DP. The system is currently constrained to evaluate priority as a function of these attributes, and does not include any adaptive features (currently the number of attributes under consideration is 36). The cluster analysis tool 203 of the present invention could therefore be used to identify attributes that appear significant from an initial data-set. Clearly, and from consideration of the reduced data set described above in the context of the first embodiment, the number of significant attributes may be significantly less than the 36. Provided the cluster analysis tool 203 generates information from which a set of rules can be extracted, the actual tool comprising the cluster tool 203 could be any of principal component analysis, cluster analysis, etc.—the selection is expected to depend on post-processing comparative analysis. Once rules describing the system behaviour have been extracted, the monitoring means 211 is operable to receive new data and apply its case-based reasoning methods as described above in the context of the first embodiment.

Consumer Targetting:

For users of communications services, a range of products is available to a network subscriber, such as Callminder™, Ringback™ etc. The implementation of such communication services involves the following considerations:

1. Are there relationships between purchase of products which indicate that certain groupings of people are likely to purchase b and c if they have bought a;

2. Are there any temporal inter-product purchasing trends.

As many products have an associated network installation or configuration requirement, for a user to be able to benefit from these products and services, the network infrastructure may require modifications. Thus if relationships can be extracted according to (1) or (2), then the network can be proactively administered, offering significant cost savings to the network operator.

The technique of association rules may be applied to consumer statistics in an attempt to identify significant patterns (patterns=combinations of attributes). Association rules search for statistically significant occurrences of predetermined combinations of attributes within a data set, starting with one attribute, then a combination of two attributes, and increasing the number of attributes comprising the combination until all attributes have been accounted for. The technique builds on the statistical significance determined at each level, such that only patterns yielding significance above a predetermined threshold are added to in the afore-described manner. For example, a combination of attributes A, B, C of length (n=3), can only pass the minimum support threshold if all of its subsets of length (n−1) pass the minimum support threshold. Thus if (A,B,C) has passed the threshold, as this can only occur if (A,B), (B,C) and (A,C) all pass a known threshold, this provides us with information about the occurrence of these combinations as well as sets of higher order.

Thus association rules generate, by definition, rules that describe statistically significant patterns, and for this application the deriving means 203 preferably comprises association rules. Once these rules have been created, they provide input to the monitoring means 211 (note that the rule extractor 207 is ineffective as association rules 203 identify rules directly), which is operable to adapt these rules over time, thereby accounting for any temporal changes in interest due to external influences and experience (concept drift). What the tool would be doing, in effect, would be sifting through information, incorporating feedback on the effectiveness of a marketing campaign.

Once significant patterns have been identified, the following features may be included in the downstreaming of consumer products:

If the attributes include time line information, and if these feature in the significant patterns, this could yield an estimate of purchasing cycles;

If the significant pattern indicates a relationship between independent products, then a subscriber can be targeted with all products in a single mail-shot;

For example if association rules were run for the following campaigns, and data on take-up collected, purchasing patterns and timescales could be identified:

If campaign 1 sells second line, (over 18 months)

then campaign 2 sells Call Minder (over 18 months)

then Campaign 3 sells Home highway (over 18 months)

then Campaign 4 sells ADSL (over 18 months)

Networks can then plan for the maximum amount of network allocation over a 6 year period, accounting for particular product behaviour, thus allocating network resources to the right place at the right time. Furthermore the adaptive feature of the invention allows modification of the time scale, factoring in short-term growth or reduction in product lines.

Thus network planning can benefit from this additional information, providing indications of what network infrastructure components should be in place and when.

This embodiment is eminently suited to e-commerce applications, where marketing profiles are designed around information gathered via loyalty cards and cookies etc.

1. A method of allocating a resource to an input entity on the basis of data in respect of entities to which resources have already been allocated, said data identifying
for each such entity, attributes of the entity and resources allocated to the entity;
a plurality of groups of entities, each group comprising rules defining comparisons to be performed between attributes of an entity and attributes characteristic of the group and comprising data identifying one or more resources typical of the group,
the method comprising the steps of:
(i) receiving attributes of an input entity to which resources are to be allocated;
(ii) performing comparisons defined by the rules so as to identify one group that meets a criterion of similarity to the input entity, and quantifying a degree of similarity between the attributes of the input entity and attributes characteristic of the group;
(iii) allocating, to the input entity, said resources typical of the identified group;
(iv) for this and subsequently received input entities, monitoring the degree of similarity quantified at step (ii); and
(v) generating an alert when the degree of similarity falls below a predetermined threshold value.

2. A method according to claim 1, further comprising monitoring the number of alerts generated at step (v) and modifying at least some of the rules defined in the groups when the number of alerts exceeds a predetermined threshold.

3. A method according to claim 2, in which the rules are modified in accordance with the attributes of the input entity.

4. A method according to any one of the preceding claims, in which the resource being allocated is a communications resource.

5. A method according to any one of the preceding claims, in which said resources typical of a group are identified by averaging the resources allocated to entities within a group.

6. Apparatus for allocating one or more resources to one or more input entities on the basis of data in respect of entities to which resources have already been allocated, the apparatus comprising:
(i) storage means for storing data in respect of entities to which resources have already been allocated, said data identifying, for each such entities, attributes of the entity and resources allocated to the entity;
(ii) deriving means arranged to analyse the stored data so as to identify a plurality of groups of entities within which the entities have similar attributes, and arranged to generate, for each group, rules defining comparisons to be performed between attributes of an input entity and attributes characteristic of the group; and data identifying resources typical of the group;
(iii) receiving means arranged to receive an input entity to which resources are to be allocated;
(iv) processing means operable to receive the input entity and the rules derived by the deriving means (ii), and arranged to perform the comparisons defined by the rules so as to identify one group that meets a criterion of similarity to the input entity, and arranged to allocate to the input entity said resources typical of the identified group, the processing means being further arranged, in the event that no group can be so identified, to generate an alert.

7. Apparatus according to claim 6, wherein the processing means (iv) is operable to modify the rules derived by the deriving means (ii) if the number of alerts generated exceeds a predetermined number.

8. Apparatus according to claim 6 or claim 7, wherein the deriving means (ii) includes means for performing cluster analysis on the stored data, and wherein the groups so derived are clusters of data.

9. Apparatus according to claim 8, wherein the deriving means (ii) includes means for extracting rules from the derived clusters.

10. Apparatus according to claim 6 or 7, wherein the deriving means (ii) includes means to perform any, or a combination of, principle component analysis, rule induction, association rule analysis and/or sequence analysis.

11. Apparatus according to any one of claims 6 to 10, wherein the resource being allocated is a communications resource.

12. A computer program comprising a set of instructions to cause a computer to perform the method according to claims 1 to 5.

13. Apparatus for allocating one or more resources to one or more input entities on the basis of data in respect of entities to which resources have already been allocated, the apparatus comprising:
server apparatus comprising:
(i) storage means for storing data in respect of entities to which resources have already been allocated, said data identifying, for each such entities, attributes of the entity and resources allocated to the entity;
(ii) deriving means arranged to analyse the stored data so as to identify a plurality of groups of entities within which the entities have similar attributes, and arranged to generate, for each group,
(iii) rules defining comparisons to be performed between attributes of an input entity and attributes characteristic of the group; and data identifying resources typical of the group;
one or more client apparatus each comprising:
receiving means arranged to receive an input entity to which resources are to be allocated;
processing means operable to receive the input entity and data indicative of the rules derived by the deriving means from the server apparatus, the processing means being arranged to perform the comparisons defined by the rules so as to identify one group that meets a criterion of similarity to the input entity, and arranged to allocate to the input entity said resources typical of the identified group, the processing means being further arranged, in the event that no group can be so identified, to generate an alert.

14. Server apparatus for use in allocating one or more resources to one or more input entities on the basis of data in respect of entities to which resources have already been allocated, the server apparatus comprising
(i) storage means for storing data in respect of entities to which resources have already been allocated, said data identifying, for each such entities, attributes of the entity and resources allocated to the entity;
(ii) deriving means arranged to analyse the stored data so as to identify a plurality of groups of entities within which the entities have similar attributes, and arranged to generate, for each group, rules defining comparisons to be performed between attributes of an input entity and attributes characteristic of the group; and data identifying resources typical of the group;
(iii) communications means for communicating with one or more client apparatus, the communications means being arranged to output data indicative of the generated rules to each client apparatus and arranged to receive data indicative of entities to which resources have already been allocated, for storage in the storage means and analysis by the deriving means.

15. Client apparatus for use in allocating one or more resources to one or more input entities on the basis of data in respect of entities to which resources have already been allocated, the client apparatus comprising:
communications means for communicating with a server apparatus, the communications means being arranged to receive data indicative of rules generated by the server apparatus, the rules defining comparisons to be performed between attributes of an input entity and attributes characteristic of groups of entities within which entities have similar attributes;
receiving means arranged to receive an input entity to which resources are to be allocated;
processing means operable to receive the input entity and data indicative of the rules, the processing means being arranged to perform the comparisons defined by the rules so as to identify one group that meets a criterion of similarity to the input entity, and arranged to allocate to the input entity said resources typical of the identified group, the processing means being further arranged, in the event that no group can be so identified, to generate an alert.
